(19) United States
(12) Patent Application Publication
(10) Pub. No.: US 2016/0288568 A1
(43) Pub. Date: Oct. 6, 2016

(54) CASTOR CONTROL SYSTEM

(71) Applicant: LINAK A/S, Nordborg (DK)

(72) Inventor: PETER BRØNDUM, LOUISVILLE, KY (US)

(73) Assignee: LINAK A/S, NORDBORG (DK)

(21) Appl. No.: 14/442,170

(22) PCT Filed: Nov. 13, 2013
(86) PCT No.: PCT/DK2013/000078

§ 371 Date: May 12, 2015

(30) Foreign Application Priority Data
Nov. 13, 2012 (DK) PA 2012 00709

(51) Int. Cl. B60B 33/00; A61G 7/05; A61G 7/10; B60B 33/02

(52) U.S. Cl. CPC B60B 33/0092; B60B 33/0068; B60B 33/026; B60B 33/021; A61G 7/05; B60B 33/0094; A61G 7/1046; A61G 2007/0528

(57) ABSTRACT

A castor control system for controlling at least two castors in a castor control system is provided. The castors comprise an electric motor which can be used to set the castor in three different positions: directional lock, neutral or braked. The castors can be operated individually from an operating panel of the castor control system. The system can also set all castors in the braked position if a motion sensor of the castor control system detects motion and the castor control system is connected to mains voltage.

The present invention relates to a castor control system and methods for operating such a system.

Castors usually comprise a fork from which a mounting pin projects vertically. In the fork a running wheel is mounted via a horizontal axle. The fork can swivel about the vertical axis of the mounting pin and the running wheel can rotate about the horizontal axis of its mounting axle. Mounted on hospital and care furniture, the castors are normally equipped with means for locking the swivel and means for braking the wheel. These means can be applied either alone or in combination. Such a castor is described in GB 2 457 787 to Oy Mannerin Konepaja AB.

In many hospital beds the brake and locking means of the castors are mechanically interconnected such that they can be operated via a pedal, for example pairwise and/or all of them. Such a bed is disclosed in EP 618 088 A2 to Hill-Rom. A further development of this principle is described in EP 1 945 166 A2 to LINET SPOL S.R.O. Here, the hospital bed comprises an actuation device which is connected to the mechanical interconnections of the castors, which can thus be operated by the actuation device. If a motion sensor on hospital bed has not detected movement for a specified period of time, a central processor unit will automatically apply the brakes of the castor wheels by means of the actuation device. The braking and/or locking of the hospital bed is easier with the use of the common actuation device. However, adding the common actuation device to the mechanically interconnected castors merely increases the total weight of the undercarriage, which makes it very heavy to move around and to maneuver.

This drawback is overcome in WO 2008/148169 A1 to Fallshaw Holdings PTY LTD which discloses a castor having a manual brake activator (pedal) which can be set in three different positions to put the castor in a directional lock, neutral or braked position. The castor can be equipped with an electronic brake activator connected to the manual brake activator of the castor. The three positions can thereby be reached by activating the manual brake activator via the electric brake activator. Hence, the castor can be operated both manually and automatically. This type of castor is however cost-intensive and thus less attractive in many contexts.

GB 2 457 787 to Oy Mannerin Konepaja AB describes a castor with a swivel lock and a wheel brake having a common activation shaft. In a first position the common activation shaft locks the swivel. In a second position the activation shaft locks the swivel and activates the wheel brake. Each castor includes a pedal for manual operation. In another embodiment the pedal is replaced with a motor actuator, such as an electric motor mounted thereon. Manual operation of the pedal or actuation of the motor will cause the common activation shaft to move between the positions mentioned.

The objective of the invention is to provide a simplified castor control system with an increased reliability, usability and safety.

According to the invention this is solved by providing a castor control system comprising an electric brake controller, a power supply, an operating panel, a motion sensor and at least two castors, where the at least two castors comprise a mounting pin with a vertical rotational axis about which the castor can swivel, at least one wheel rotatable about a horizontal axis and an electric motor cooperating to set the castor in:

a directional lock position where the castor cannot swivel about the vertical axis of the mounting pin and the wheel can rotate freely about the horizontal axis, or a brake position where the wheel cannot rotate about the horizontal axis and where the castor cannot swivel about the vertical axis of the mounting pin, or

a neutral position where the castor can swivel freely about the vertical axis of the mounting pin and the wheel can rotate freely about the horizontal axis,

and where the electric motor of each castor is connected to the electric brake controller which can operate each castor individually.

The castor control system thus provides control of the castors either individually, in pairs or as a plurality.

In a further development the electric brake controller of the castor control system comprises a printed circuit board which comprises the motion sensor. The motion sensor can be an accelerometer. Further the electric brake controller of the castor control system comprises a microprocessor.

In another development the electric brake controller of the castor control system comprises a voltage source detector to determine whether or not the castor control system is connected to mains voltage.

The present invention also provides a method for operating a castor control system where the electric brake controller, via the electric motor of each castor, can set each castor in the brake position if the motion sensor detects motion and the voltage source detector detects that the castor control system is connected to mains voltage, or the motion sensor has not detected movement for a specified period of time. In the case that the castor control system is installed in an article of hospital or care furniture the mains power supply is normally provided via a cable with a plug connected to a wall socket. The castor control system will here prohibit that this cable is ripped out of the wall thus avoiding damages to equipment and personal injury. In addition hidden damages to the cable, such as cutting off conducting wires or short circuiting of the conducting wires, caused by tearing out the cable of the wall are also avoided. If the castor control system is installed in an article of hospital or care furniture and the castors are set in the brake position due to non-movement, this can prohibit fall accidents because a patient will be able to use the hospital bed or care furniture as anchor for example when (s)he is leaving a hospital bed.

In a further development the present invention provides a hospital bed or an article of care furniture comprising a castor control system mentioned above operating according to the method also mentioned above.

The present invention also relates to a patient lift comprising a castor control system as described above.

Further characteristics of the present invention are described in the following, where:

FIG. 1 illustrates a castor,

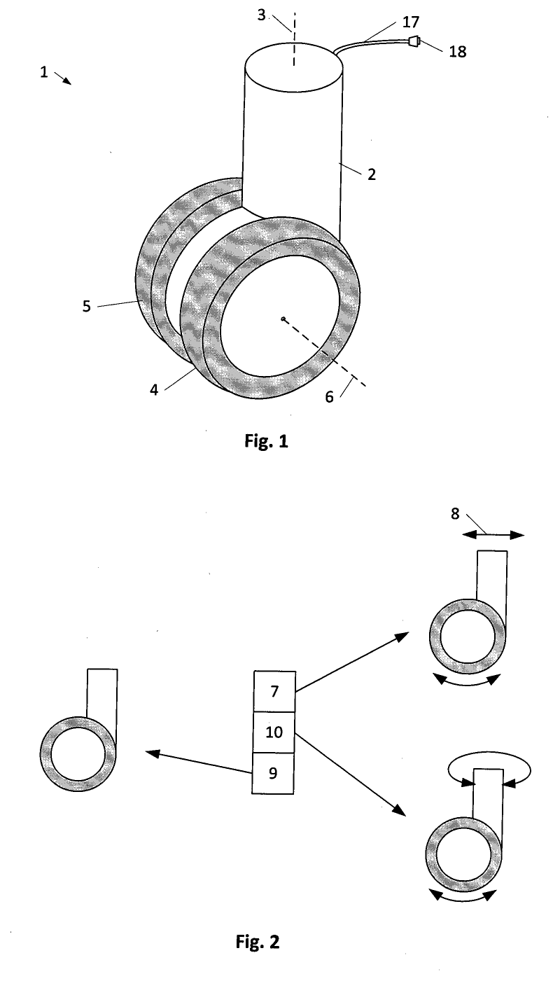

FIG. 2 illustrates the three positions, in which the brake activator of the castor in FIG. 1 can be set,

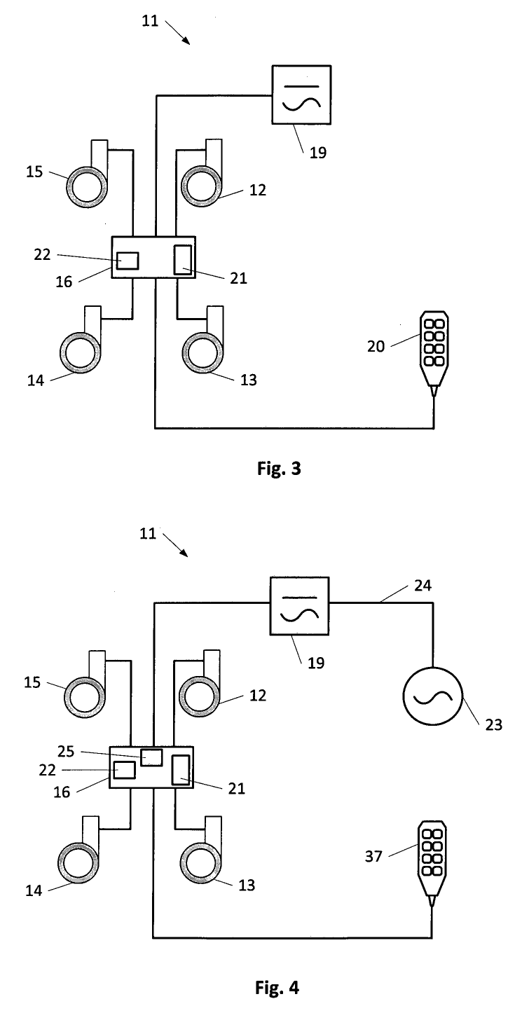

FIG. 3 schematically illustrates a castor control system comprising four castors of the type illustrated in FIG. 1,

FIG. 4 schematically illustrates a castor control system comprising four castors of the type illustrated in FIG. 1, where the system further comprises a main voltage detector,

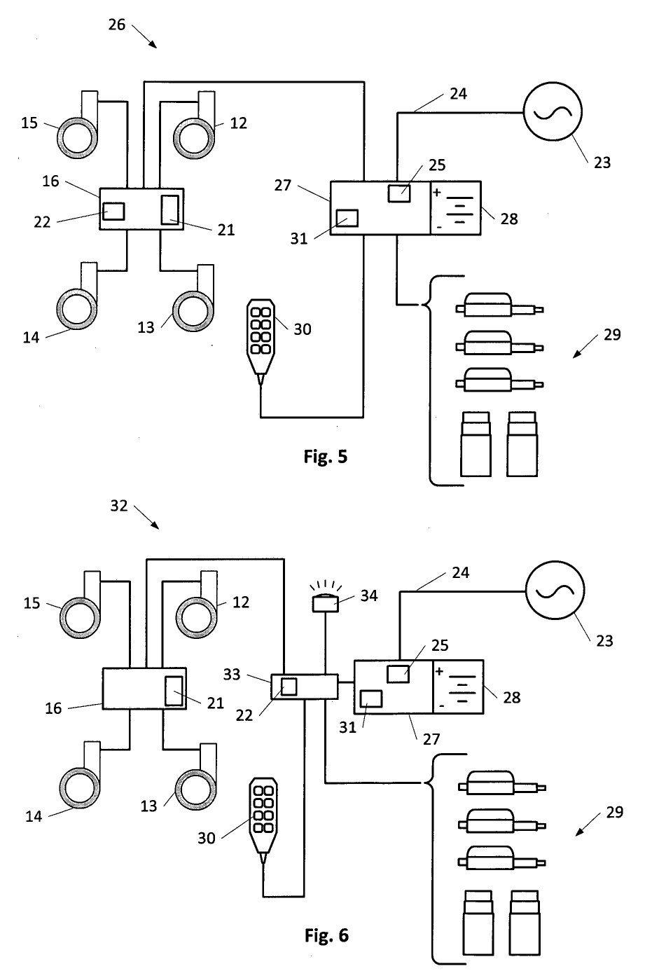

FIG. 5 illustrates a linear actuator system incorporating a castor control system of the type illustrated in FIGS. 3 and 4,

FIG. 6 illustrates a hospital or care bed incorporating the linear actuator system illustrated in FIG. 5, and

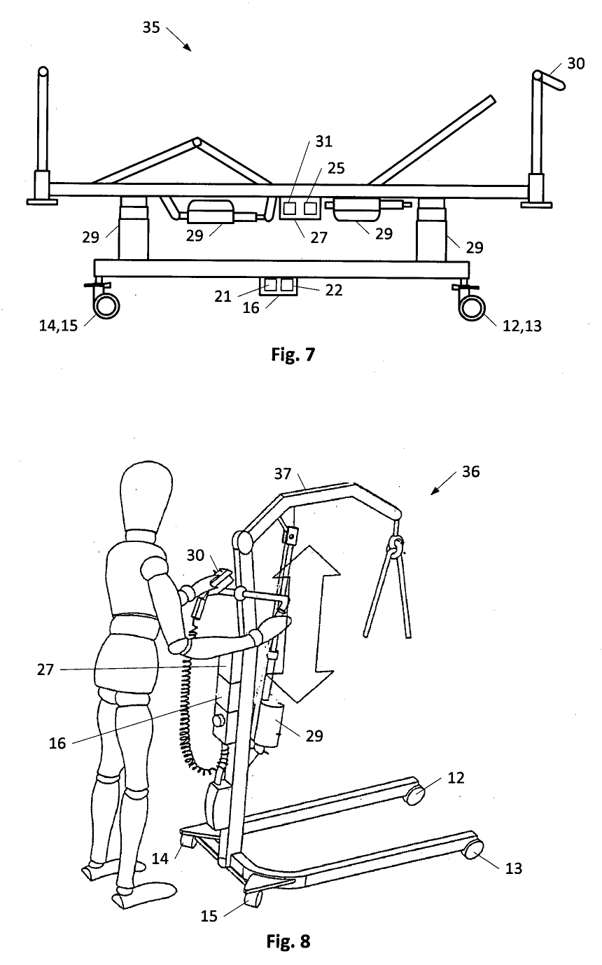

FIG. 7 illustrates a patient lift incorporating the linear actuator system illustrated in FIG. 5.

FIG. 1 illustrates a castor 1 with a mounting pin 2 having a vertical rotational axis 3 about which the castor 1 can swivel. The castor 1 comprises a set of wheels 4,5 which can rotate about a horizontal axis 6. An electric motor is arranged inside the mounting pin 2. By operating the electric motor the castor can be set in three different positions. As illustrated in FIG. 2 in position 7 (directional lock) the castor 1 is locked in a given direction 8. This means that the wheel 4,5 can rotate freely, however the mounting pin 2 is locked in a preferred direction. This allows the castor 1 to travel along a surface in the direction 8. If the electric motor is set in position 9 (Braked), the castor 1 will be fully locked or braked. This means that the castor 1 cannot swivel about the vertical axis 3 of the mounting pin 2 and the wheels 4,5 cannot rotate about the horizontal axis 6. Hence, the castor 1 is completely immovable. Setting the electric motor in position 13 (neutral) will allow the castor 1 to swivel freely about the vertical axis 3 of the mounting pin 2 and the wheels 4,5 to rotate freely about the horizontal rotation axis 6.

FIG. 3 schematically illustrates a castor control system 11 comprising four castors 12,13,14,15 of the castor 1 type with the electric motor described above. The castor control system 11 could purposefully be utilized when mounted in an article of hospital or care furniture (see FIG. 6) or a patient lift (see FIG. 7). Each of the castors 12,13,14,15 is connected to the electric brake controller 16 via the connector cable 17 having a plug 18. The electric brake controller 16 houses a printed circuit board to which the the power supply 19 and the operating panel 20 is connected. The printed circuit board comprises a controller 21 such as a microprocessor and a motion sensor 22.

All four castors 12,13,14,15 can be set in any of the positions 7,9,10 by operating the operating panel 20.

When the castor control system 11 is mounted in an article of hospital or care furniture it is convenient if one or a pair of the castors 12,13,14,15 can be set in the directional lock position 7. This will allow the operator to better move the article of hospital or care furniture from one place to another. Also here the castors 12,13,14,15 can be operated via the operating panel 20 to obtain this setting. When one or a pair of the castors 12,13,14,15 is set in the position 7 (directional) the others are at the same time set in the position 9 (neutral).

FIG. 4 illustrates a castor control system comprising a main voltage detector. Seeking to increase the safety, the castor control system 11 installed in the article of hospital or care furniture is programmed with a brake time delay for setting all the castors 12,13,14,15 in the locked position 9 if the hospital or care furniture has not been in motion in a predetermined period of time. Whether or not there has been motion is detected by the motion sensor 22 and the data from the motion sensor 22 is processed by the controller 21.

As illustrated in FIG. 4 the electric brake controller 16 is connected to the power supply 19. The electric brake controller 16 can optionally be supplied with power from a mains voltage source mains 23 via a cable 24 inserted in a wall socket. In the event that the article of hospital or care furniture comprising the castor control system 11 is moved without being disconnected from the mains 23, the cable 24 could cause a dangerous situation for people or equipment in proximity of the article of furniture. Further, if the cable 24 is pulled out of the wall socket this could damage the wall socket and the plug of the cable could hit people or equipment in proximity thereof. Even worse, hidden damages to the cable 24 could be caused by tearing the cable 24 out of the wall. Such damages could e.g. be cutting the conducting wires of cable 24 or damaging the isolation of the conducting wires such that a short circuit could occur. Consequently the electric brake controller 16 comprises a voltage source detector 25 for determining whether the electric brake controller 16 is connected to mains voltage 23.

If the voltage source detector 25 detects that the electric brake controller 16 is connected to mains voltage 23 and the motion sensor 22 registers motion, the castor control system 11 sets the castors 12,13,14,15 in the braked position 9 and/or provides a visual/audible/tactile alarm. By disconnecting the electric brake controller 16 from mains voltage 23, the hospital or care furniture can be moved without triggering the brake activation and/or the alarm.

FIG. 5 illustrates the castor control system 11 incorporated in a linear actuator system 26. The linear actuator system 26 comprises a control box 27 supplied with power from a battery 28 or mains voltage 23. The linear actuator system 26 further comprises a number of linear actuators 29 and an operating panel 30 both connected to the control box 27. The electric brake controller 16 is connected to and powered by the controller 31 in the control box 27. The castor control system 11 can hereby be controlled by the operating panel 30 via the control box 27. Through the same connection the electric brake controller 16 can provide feedback to the control box 27. In the linear actuator system 26 the control box 27 operates as a master and the electric brake controller 16 as a slave. However, the electric brake controller 16 still comprises a controller 21.

Although not illustrated the linear actuator system 26 could also comprise an additional operating panel. As illustrated the motion sensor 22 is arranged in the electric brake controller 16, but could also be arranged in the control box 27 or in a linear actuator 29. The voltage source detector 25 has conveniently been arranged in the control box 27. The linear actuators 29 are of a type comprising a thrust rod. This type of linear actuator comprises a spindle with a spindle nut. The spindle is driven by a reversible electric motor through a transmission. When the spindle is driven, the spindle nut is moved in an inwards or outwards direction depending on the direction of rotation of the electric motor. The linear actuator is a separate product with the spindle, transmission and electric motor enclosed in a housing. The housing typically consists of a motor housing and an outer tube. An inner tube is secured to the spindle nut. The inner tube is displaced in and out of the outer tube as the spindle nut is moved in and out on the spindle. In the opposite end of the spindle nut the inner tube comprises a front mounting. The outer side of the motor housing is furnished with a rear mounting. The front mounting and rear mounting are used to secure the linear actuator in the structure which should be adjusted.

FIG. 6 illustrates another embodiment of the linear actuator system 26 in FIG. 5. The linear actuator system 32 in FIG. 6 comprises a junction box 33 connected to the electric brake controller 16, the operating panel 30 and the linear actuator 29. Further an under bed light 34 is added to the linear actuator system 29 and connected to the junction box 33. The junction box 33 is connected to the control box 27 in a single connection. In this embodiment the motion sensor 22 is arranged in the junction box 33.

FIG. 7 schematically illustrates a hospital or care bed 35 incorporating the linear actuator system 26 shown in FIG. 5. Although not shown the hospital or care bed 31 comprises four castors 12,13,14,15, hence the double references for the two castors illustrated. The linear actuators 29 can be used to elevate the upper frame carrying the mattress of the bed relative to the undercarriage. The linear actuators 29 can also be used to elevate the head rest, back rest and leg rest of the bed 31.

FIG. 8 illustrates a patient lift 36 incorporating the linear actuator system 26 of FIG. 5. Here, the linear actuator 29 is used to move the arm 37 up and down, so as to lift a patient.

1. A castor control system comprising
an electric brake controller,
a power supply connected to the electric brake controller,
an operating panel connected to the electric brake controller,
the electric brake controller comprising a motion sensor,
and at least two castors, where the at least two castors comprises a mounting pin with a vertical rotational axis about which the castor can swivel, at least one wheel rotatable about a horizontal axis and an electric motor cooperating to set the castor in one of:
a directional lock position where the castor cannot swivel about the vertical axis of the mounting pin and the wheel can rotate freely about the horizontal axis, or
a brake position where the wheel cannot rotate about the horizontal axis and where the castor cannot swivel about the vertical axis of the mounting pin or,
a neutral position where the castor can swivel freely about the vertical axis of the mounting pin and the wheel can rotate freely about the horizontal axis,
and where the electric motor of each castor is connected to the electric brake controller which can operate each castor individually.

2. A castor control system according to claim 1, where the electric brake controller comprises a microprocessor.

3. A castor control system according to claim 1, wherein the electric brake controller comprises a printed circuit board on which the microprocessor and the motion sensor are arranged.

4. A castor control system according to claim 3, comprising a voltage source detector to determine whether or not the castor control system is connected to mains voltage.

5. A castor control system according to claim 3, where the motion sensor is an accelerometer.

6. A castor control system according to claim 4, where the electric brake controller, via the electric motor of each castor, can set each castor in the brake position if the motion sensor detects motion and the voltage source detector detects that the castor control system is connected to mains voltage, or the motion sensor has not detected movement for a specified period of time.

7. A castor control system according to claim 1, wherein the mounting pin is configured to be coupled to a hospital or care bed.

8. A castor control system according to claim 7 further comprising at least one linear actuator.

9. A castor control system according to claim 6, wherein the mounting pin is configured to be coupled to a hospital bed or care bed and further comprising at least one linear actuator.

10. A castor control system according to claim 1, wherein the mounting pin is configured to be coupled to a patient lift.

11. The castor control system according to claim 10, further comprising at least one linear actuator.

12. A castor control system according to claim 6, wherein the mounting pin is configured to be coupled to a patient lift and further comprising at least one linear actuator.
